(19) United States
(12) Patent Application Publication
(10) Pub. No.: US 2016/0176614 A1
(43) Pub. Date: Jun. 23, 2016

(54) MICROWAVE SAFE CONTAINER

(71) Applicant: Casa Brands India Pvt. Ltd., New Delhi (IN)

(72) Inventors: Neeraj Mittal, New Delhi (IN); Umang Srivastava, New Delhi (IN)

(21) Appl. No.: 14/885,835

(22) Filed: Oct. 16, 2015

(30) Foreign Application Priority Data
Dec. 19, 2014 (IN) 3782DEL2014

(51) Int. Cl. B65D 81/34; B23P 19/00

(52) U.S. Cl. CPC B65D 81/3453; B23P 19/00

(57) ABSTRACT

A microwave safe container may include a metal receptacle enclosed in an outer covering of a substantially microwave-transparent material. The metal receptacle and the outer covering each include a closed end and an open end. The open end of the metal receptacle is joined to the open end of the outer covering to form a substantially rounded top lip while maintaining a space between the metal receptacle and the outer covering. The arrangement of the microwave safe container allows microwave rays to penetrate the metal receptacle without getting completely reflected resulting in substantially even heating of food inside the microwave safe container.

### CROSS REFERENCE TO RELATED APPLICATION

This application claims priority to Indian Patent Application No. 3782/DEL/2014 dated Dec. 19, 2014, the entire contents of which are incorporated by reference herein.

### FIELD OF INVENTION

The present invention relates to a container having metallic inner surface that is safe for use in microwave oven and a process for manufacture of the same.

### BACKGROUND OF THE INVENTION

Use of microwave ovens for heating food for cooking or reheating previously cooked foods is a very prevalent practice. Typically containers made from plastic, paper, ceramic or glass are commonly utilized in a microwave oven, since these materials are transparent to microwave energy and the energy is absorbed by the objects inside the container which are thus heated. Use of metal inside a microwave oven is not an accepted practice since bare metal can reflect the microwaves back to the magnetron inside the microwave oven resulting in damage to the magnetron. Also, containers made of metal are known to cause arcing between the container and other metal objects in the oven, including the oven walls.

Glass and ceramic materials are not popular for use in microwave due to their fragile nature and higher weight of containers made of these materials. Paper containers are not sufficiently sturdy and also do not provide necessary barrier for vapour and hence are not suitable for use as containers for food products. It is due to these reasons, that plastic has become the most popular material for use in microwave ovens for cooking and especially reheating. However, recent researches have shown that when heated, there is a tendency for many plastics to leach chemicals which are very harmful for health. These chemicals are believed to cause a lot of health issues like obesity, hit fertility rate giving rise to reproductive problems, and cancer. Thus, plastic cannot be considered completely safe material for use in the microwave. Also plastic containers are not considered environment friendly.

Attempts have been made in the past to produce containers wherein the metal container has been coated with non-reflective material such as those described in U.S. Pat. No. 5,961,872 and U.S. Pat. No. 4,558,198 the contents of which are incorporated herein by reference. However, such solutions have not been very effective because either their the side walls of the containers are limited to in height to about 3.5 inches, or because a coating is required to be put both on the outside as well as the inside surface of the metal and the shape of the container also needs to be strictly controlled. In the event these conditions are not met, the food in the containers does not get heated consistently or the containers are prone to arcing. Due to these limitations, it has not been possible to put any such products to successful commercial use and hence even today, all microwaving happens either in plastic, ceramic or glass storage containers.

Thus, there is an unmet need in the market for a microwave safe container wherein the surface in contact with the food is substantially inert and does not cause harmful chemical substances to be leached into the food being heated while being easy to manufacture and simultaneously being simple to maintain for household use. In other words, a container which is food safe as well as microwave safe.

### SUMMARY OF THE INVENTION

The following summary is provided to facilitate an understanding of some of the innovative features unique to the disclosed embodiments and is not intended to be a full description. A full appreciation of the various aspects of the embodiments disclosed herein can be gained by taking into consideration the entire specification, claims, drawings, and abstract as a whole.

A microwave safe container is provided having a metallic inner surface which is covered on the outside surface with a covering material that is substantially transparent to microwaves such that there is space maintained between the two surfaces which are joined only at the top side of the microwave safe container to form a substantially rounded top lip.

A process for the manufacture of the microwave safe container of the invention is also provided comprising:—selecting a metal receptacle having a closed end and an open end; selecting an outer covering of a substantially microwave-transparent material having a closed end and an open end; bending the open end of the outer covering to form a flattened edge, bending the open end of said metal receptacle to form an inverted U-shaped edge; placing the inverted U-shaped edge of the metal receptacle over the flattened edge of the outer covering while maintaining a space (or gap) between the metal receptacle and the outer covering and joining the inverted U-shaped edge of the metal receptacle and the flattened edge of the outer covering to form a microwave safe container having substantially rounded top lip.

Other aspects and advantages of the invention will become apparent from the following detailed description, taken in conjunction with the accompanying drawings, illustrating by way of examples the principles of the invention.

### BRIEF DESCRIPTION OF THE DRAWINGS

FIG. 1 is a representation of a preferred embodiment of the present invention a microwave safe container 100 having a metal receptacle and a microwave transparent outer covering.

FIG. 1A shows an exploded view of the space maintained between the metal receptacle and the outer covering.

FIG. 2 is a view of the metal receptacle and the outer covering prior to the joining process to construct the microwave safe container of the present invention.

FIG. 3 is an exemplary diagrammatic description of the steps followed in the construction of the container of the present invention.

### DETAILED DESCRIPTION OF THE INVENTION

The present invention overcomes the problems of the prior art and provides a microwave safe container comprising a metal receptacle which forms the inner surface of the container of the invention and an outer covering of a substantially microwave transparent material such that the said metal inner container and outer covering form a substantially rounded top lip while maintaining a space (or gap) between the metal receptacle and the outer covering. The present invention also provides a process for manufacture of the microwave safe container.

In particular, the present invention relates to a microwave safe container comprising a combination of the metal surface of a metal receptacle made of a material such as stainless steel and an outer covering of a microwave transparent material such as polypropylene. The container of the present invention does not have any limitation as to the height of the sidewalls or the necessity for any coating on the metal receptacle. There is also no necessity of creating a vacuum between layers of the container of the present invention. The container of the present invention is configured to hold a predetermined amount of food or liquid which is required to be reheated or cooked. The container of the invention is safe for heating food inside the microwave without any difficulties. The present invention combines the food safety properties of metal such as stainless steel with the substantially microwave transparent properties of outer covering in a manner such that the container is safe to for use in a microwave. In addition, the container of the present invention is simple and easy to manufacture and more friendly for household use.

In the most preferred embodiment the present invention provides a metal receptacle having an open end and a closed end enclosed in an outer covering of a substantially microwave-transparent material having a closed end and an open end and a space between the metal receptacle and the outer covering wherein, the open end of the open receptacle is joined to the open end of the outer covering to form a substantially rounded top lip while maintaining the space between the metal receptacle and the outer covering. The metal receptacle has a thickness of about 0.2 mm to 1.5 mm. The thickness of outer covering is in the range of about 0.3 mm to 3.0 mm. The space between the metal receptacle and the outer covering is in the range of about 0.05 mm to 1.5 mm. The top lip has a thickness in the range of 1 mm to 5 mm.

In another preferred embodiment, the metal receptacle has a thickness of about 0.3 mm to 0.5 mm, the outer covering has a thickness in the range of about 0.8 mm to 1.2 mm, the space between the metal receptacle and the outer covering is in the range of 0.05 mm to 0.5 mm while the top lip has a thickness of 2 mm to 4 mm.

In yet another preferred embodiment, the metal receptacle is constructed of a material selected from steel, aluminium, stainless steel, copper, brass or combinations thereof. The preferred substantially microwave-transparent materials for the outer covering are selected from Polypropylene (PP), Polypropylene Co Polymer (PPCP), High-density polyethylene (HDPE), low-density polyethylene (PELD), Linear Low-Density Polyethylene (LLDP), silicone, silicone rubber, nylon or combinations thereof.

In yet another embodiment, the container of the invention may optionally comprise a lid. The lid is preferably constructed from a material selected from plastics such as polypropylene (PP), Polypropylene Co Polymer (PPCP), High-density polyethylene (HDPE), low-density polyethylene (PELD), linear low-density polyethylene (LLDP), silicone, silicone rubber, nylon or their combinations. The thickness of the lid may vary from about 1 mm to 2.5 mm. The lid may optionally be equipped with a releasable steam vent which may be opened during use of container in the microwave for allowing the steam to escape during use.

In another embodiment, the present invention also relates to a process for the manufacture of a microwave safe container comprising:—selecting a metal receptacle having a closed end and an open end; selecting an outer covering of a substantially microwave-transparent material having a closed end and an open end, bending the open end of the outer covering to form a flattened edge; bending the open end of the metal receptacle to form an inverted U-shaped edge; placing the inverted U-shaped edge of the metal receptacle over the flattened edge of the outer covering while maintaining a space between the metal receptacle and the outer covering; and joining the inverted U-shaped edge of the metal receptacle and the flattened edge of the outer covering to form a microwave safe container of the present invention having a substantially rounded top lip.

In another embodiment, the bending of the open end of the metal receptacle is carried out in a two stage process by firstly bending the open end of the metal receptacle to form an edge substantially parallel to the base of the metal receptacle and re-bending said edge to form an inverted U-shaped edge having a first plane parallel to the base of the metal receptacle and a second plane perpendicular to the base of the metal receptacle. In yet another preferred embodiment the joining of the inverted U-shaped edge of the metal receptacle with the flattened edge of the outer covering is carried out by curling and crimping the inverted U-shaped edge over the flattened edge of the outer covering.

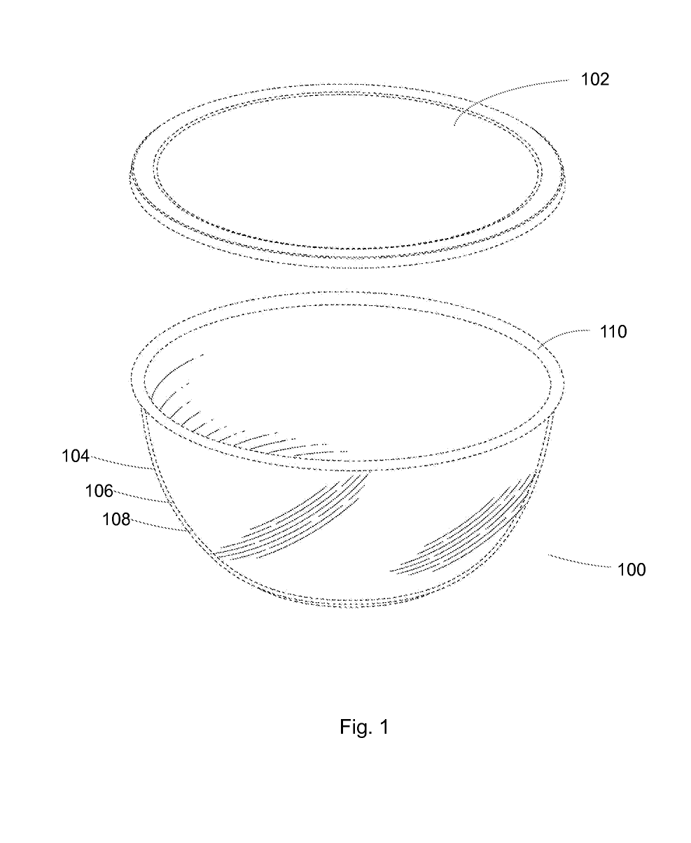

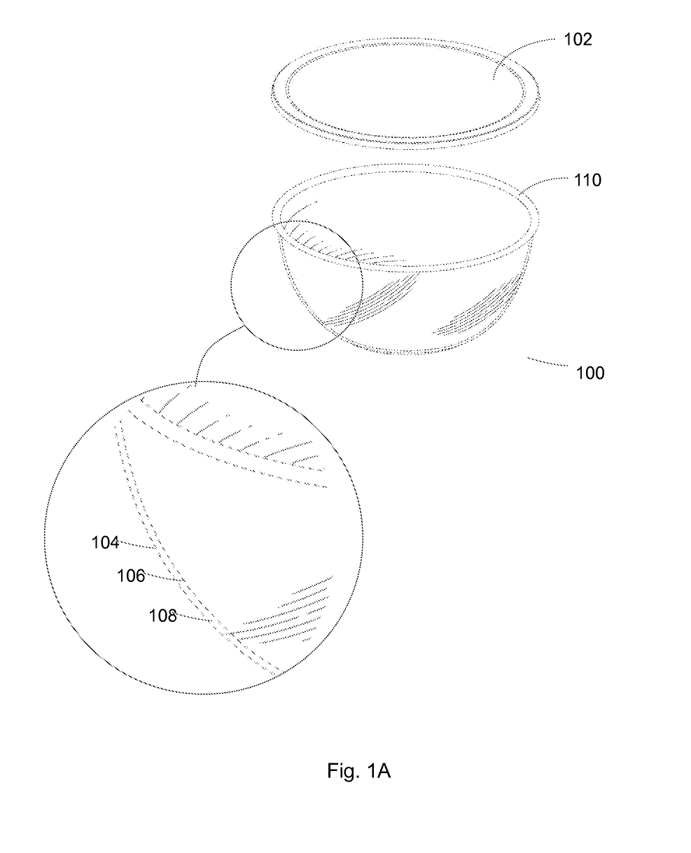

Referring now to the drawings, FIG. 1 is an example of a preferred embodiment of the present invention. It shows a microwave safe container of the present invention 100 comprising an inner metal receptacle 106 with an outer covering 104 constructed of a substantially microwave-transparent material. The metal receptacle 106 and outer covering 104 are joined together at their open end to form a substantially rounded top lip 110 in such a manner such that a space 108 is maintained between the metal receptacle 106 and the outer covering 104. An openable lid 102 may optionally be provided with the container 100. FIG. 1A shows an exploded view depicting space 108 maintained between the metal receptacle 106 and the outer covering 104 in the container of the present invention.

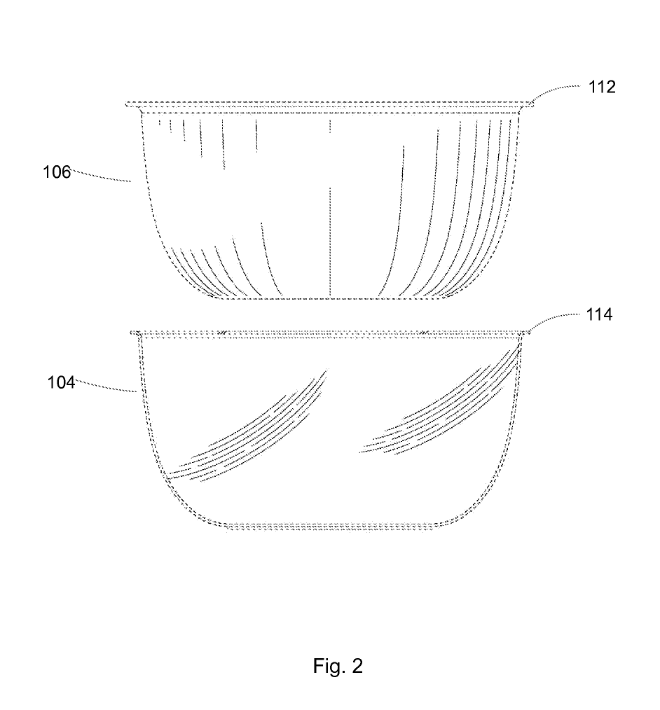

FIG. 2 shows the metal receptacle 106 and the outer covering 104 prior to being joined together by the process of the present invention to form the microwave safe container 100.

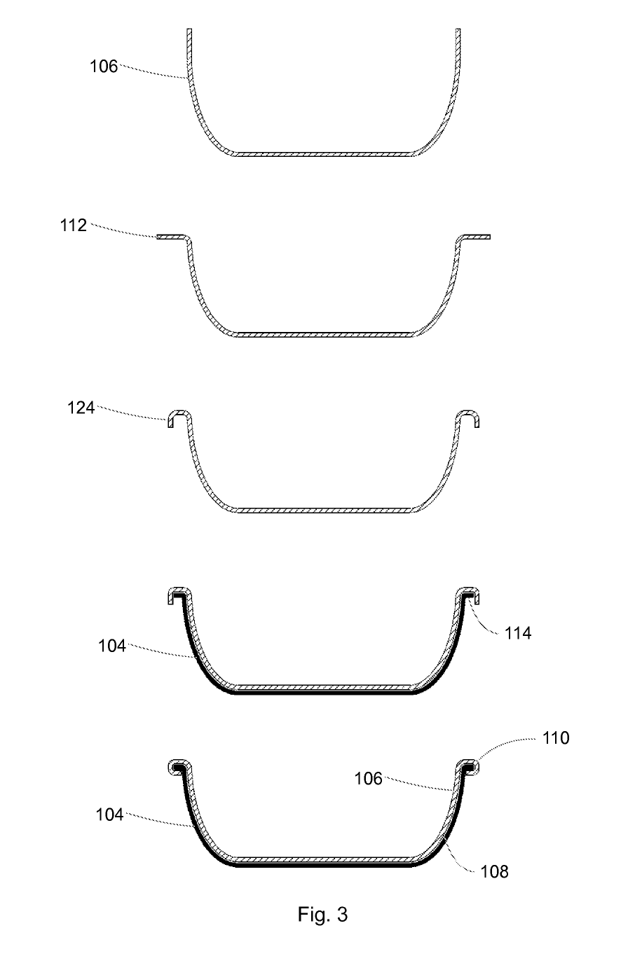

FIG. 3 presents another preferred embodiment of the process for joining together the metal receptacle 106 and the outer covering 104 to form a microwave safe container 100 of the invention by creating a substantially rounded top lip 110 while maintaining a gap 108 between the metal receptacle 106 and the outer covering 104. The metal receptacle 106 is selected and its outer end is flattened such that a flattened edge 112 parallel to the base of the receptacle is formed. A part of the flattened edge 112 is further bent to make a inverted U-shaped edge 124. The outer end of the outer covering 104 is also flattened to form a flattened edge 150 and the inverted U-shaped edge 124 of the metal receptacle is placed over the flattened edge 150 of the outer covering 104. The inverted U-shaped edge 124 of the metal receptacle is then joined with the flattened edge 114 preferably by curling and crimping it over the flattened edge 114 to form a substantially rounded top lip 110 while maintaining a gap between the metal inner receptacle 108 and the outer covering 104.

The present invention provides a commercially and practically viable arrangement of a microwave safe container and a process for manufacture of the same. The present arrangement allows penetration of the microwave rays to reach the inner metallic layer and these rays are also able to penetrate the metal without getting completely reflected resulting in the substantially even heating of the food inside the container of the invention. Furthermore, usage of outer covering made from substantially microwave transparent material allows the microwave rays pass easily without much obstruction and additionally it gives the container, an attractive look with a view of the metallic inner lining. The substantially round beading at the top lip leaving a gap between the two layers achieved by the process of the present invention allows the creation of a strong integrated bond between the inner and outer layers and confers it with an additional advantage of being dishwasher safe.

The microwave safe container of the present invention can be made in any sizes or shapes including but not limited to spherical, hemispherical, square, circular, rectangular, octagonal, flower shaped or any other shapes as desired. The combined effect of the present arrangement makes it appear to be substantially metallic container while at the same time being microwave safe and also which heats the food inside the bowl properly without coming in contact with outer covering of plastics or other materials which although microwave transparent, may be harmful for food storage or reheating.

Although the foregoing invention has been described in terms of certain preferred embodiments, other embodiments will be apparent to those of ordinary skill in the art from the disclosure herein. Additionally other combinations, omissions, substitutions, and modifications will be apparent to the skilled artisan in view of the disclosure herein. It is contemplated that various aspects and features of the invention described can be practiced separately, combined together, or substituted for one another, and a variety of combination and sub-combinations of the features and aspects can be made and still fall within the scope of the invention. Accordingly, the present invention is not intended to be limited by the recitation of the preferred embodiments.

What is claimed is:

1. A microwave safe container comprising:
a metal receptacle having a closed end and an open end;
an outer covering of a substantially microwave-transparent material having a closed end and an open end; and
a space between the metal receptacle and the outer covering;
wherein, the open end of the metal receptacle is joined to the open end of the outer covering to form a substantially rounded top lip while maintaining said space between the metal receptacle and the outer covering.

2. The microwave safe container of claim 1, wherein the metal receptacle has a thickness ranging from about 0.2 mm to about 1.5 mm.

3. The microwave safe container of claim 1, wherein the outer covering has a thickness ranging from about 0.3 mm to about 3.0 mm.

4. The microwave safe container of claim 1, wherein the substantially rounded top lip has a thickness of about 1 mm to about 5 mm.

5. The microwave safe container of claim 1, wherein the metal receptacle is constructed of a material selected from the group consisting of steel, aluminium, stainless steel, copper, brass or combinations thereof.

6. The microwave safe container of claim 1, wherein the outer covering is constructed of a material selected from the group consisting of Polypropylene, Polypropylene Co Polymer, High-density polyethylene, Low-density Polyethylene, Linear Low-density Polyethylene, silicone, silicone rubber, nylon or combinations thereof.

7. The microwave safe container of claim 1, wherein the space between the metal receptacle and outer covering is ranging from about 0.05 mm to about 1.5 mm.

8. The microwave safe container of claim 1, further comprising a lid.

9. The microwave safe container of claim 8, wherein the lid has a thickness ranging from about 1 mm to about 2.5 mm.

10. The microwave safe container of claim 8, wherein the lid is configured with a steam vent.

11. A microwave container comprising:
a metal receptacle of thickness in the range of about 0.2 mm to about 1.5 mm having a closed end and an open end;
an outer covering of a substantially microwave-transparent material of thickness in the range of about 0.3 mm to about 3.0 mm having a closed end and an open end; and
a space between the metal receptacle and the outer covering in the range of 0.05 mm to 1.5 mm,
wherein the open end of the metal receptacle is joined to the open end of outer covering to form a substantially rounded top lip while maintaining said space between the metal receptacle and the outer covering.

12. The microwave container of claim 11, wherein the metal receptacle is constructed of a material selected from the group consisting of steel, aluminium, stainless steel, copper, brass or combinations thereof.

13. The microwave container of claim 11, wherein the outer covering is constructed of a material selected from the group consisting of Polypropylene, Polypropylene Co Polymer, High-density polyethylene, Low-density Polyethylene, Linear Low-density Polyethylene, silicone, silicone rubber, nylon or combinations thereof.

14. A process for the manufacture of a microwave safe container comprising:
selecting a metal receptacle having a closed end and an open end;
selecting a outer covering of a substantially microwave-transparent material having a closed end and an open end;
bending the open end of the microwave transparent outer covering to form a flattened edge;
bending the edges at the open end of said metal receptacle to form an inverted U-shaped edge;
placing the inverted U-shaped edge of the metal receptacle over the flattened edge of the outer covering while maintaining a space between the metal receptacle and the outer covering; and
joining the inverted U-shaped edge of the metal receptacle and the flattened edge of substantially outer covering to form a microwave safe container having substantially rounded top lip.

15. The process of claim 14, wherein the joining the inverted U-shaped edge of the metal receptacle and the flattened edge of the outer covering is carried out by curling and crimping the inverted U-shaped edge over the flattened edge of the outer covering to form a substantially rounded top lip.
